(19) United States
(12) Patent Application Publication
(10) Pub. No.: US 2010/0036793 A1
(43) Pub. Date: Feb. 11, 2010

(54) Method and System for Geospatial Forecasting of Events Incorporating Data Error and Uncertainty

(76) Inventors: Ruth P. Willis, Alexandria, VA (US); Gregory S. Schmidt, Laurel, MD (US); Jason Goffeney, Alexandria, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(21) Appl. No.: 12/505,972

(22) Filed: Jul. 20, 2009

Related U.S. Application Data
(60) Provisional application No. 61/081,837, filed on Jul. 18, 2008.

(51) Int. Cl. G06N 5/02

(52) U.S. Cl. 706/52; 706/58

(57) ABSTRACT

A system and method for geospatial forecasting of events that incorporates data error and uncertainty can be provided. The geospatial forecasting system can include a boundary module that is configured to define a geospatial boundary. A layer information and event information module can be provided that is configured to store layer information and event information related to the geospatial boundary. The event information can include location, or position, data about an event. Furthermore, a layer information and event information uncertainty module can be provided that is configured to incorporate data error into the layer information and event information. Finally, a geospatial forecasting module can be configured to receive the layer information and event information with the incorporated data error and process the layer information and event information to determine one or more future events.

### CROSS-REFERENCE TO RELATED APPLICATIONS

This application claims priority to provisional patent application entitled, “Method and System for Geospatial Forecasting of Events Incorporating Data Error and Uncertainty,” filed on Jul. 18, 2008, and assigned U.S. application Ser. No. 61/081,837; the entire contents of which are hereby incorporated by reference.

### FIELD OF THE INVENTION

The present invention relates generally to geospatial event forecasting systems, and more particularly relates to a system and method for applying sources of uncertainty arising within input event and feature data toward the generation of intermediate and final products of the geospatial forecasting systems.

### BACKGROUND

Geospatial event forecasting relies on using information about past events coupled with their relation to pertinent features (e.g., geospatial, geographic, demographic, and economic features) to assist in the planning for similar future events. The forecasting can offer an approach to solutions to a variety of corporate, governmental and individual problems. For example, intelligence analysts and military planners can utilize geospatial event forecasting to predict where terrorists are likely to attack, and to better plan the deployment of security forces and sensing equipment.

In the prior art, one approach for geospatial forecasting of events in a bounded geographic region involves proximity measurements between past events, geographic information system (GIS) features, and grid cells. In this approach, the proximity measurements are estimated using the distance between the reported centers of the event location and GIS features and used in a function to estimate the likelihood of a future event at the given grid cells. Traditionally, these measurement estimations have not accounted for measurement inaccuracy (e.g., global positioning system (GPS) error), mapping inaccuracy (e.g., GIS error), currency, provenance, and location uncertainty (e.g., analyst error), yet the impact on the forecasts can be quite substantial. For example, a small amount of data error can lead to a shift in location of several city blocks where an event is likeliest to occur. Previous systems, such as U.S. Pat. No. 7,120,620, cover the “traditional” geospatial forecasting approach, but do not account for data error and uncertainty, both critical elements for producing accurate forecasts.

Accordingly, there remains a need in the art for a geospatial forecasting system and method that incorporates both data error and uncertainty measurements toward the generation of intermediate and final products of the forecasting systems.

### SUMMARY OF THE INVENTION

In an exemplary embodiment of the present invention, a method for geospatial forecasting of events can be provided. A geospatial boundary can be defined and then a plurality of layer information and event information related to the geospatial boundary can be received. The event information can include location data. Data error related to the layer and event information can be incorporated into the layer information and event information assigning confidence values to the layer information and event information. The confidence values can be assigned by creating a confidence scale; assigning a low confidence value at one end of the confidence scale; assigning a high confidence value at the opposite end of the confidence scale; and determining a confidence value for the layer information and event information based on the confidence scale. Finally, the layer information and event information in a forecasting algorithm can be processed.

In another exemplary embodiment of the present invention, a method for incorporating data error and uncertainty into a geospatial forecasting of events can be provided. Event data related to one or more past events can be received, wherein the event data can include location data. Confidence values can be assigned to each of the past events by creating a confidence scale; assigning a low confidence value at one end of the confidence scale; assigning a high confidence value at the opposite end of the confidence scale; and determining a confidence value for each event based on the confidence scale. The confidence values and event data can then be incorporated into a forecasting algorithm, where the forecasting algorithm processes the information to determine one or more future events.

In another exemplary embodiment of the present invention, a system for geospatial forecasting of events that incorporates data error and uncertainty can be provided. The geospatial forecasting system can include a boundary module that is configured to define a geospatial boundary. A layer information and event information module can be provided that is configured to store layer information and event information related to the geospatial boundary. The event information can include location, or position, data about an event. Furthermore, a layer information and event information uncertainty module can be provided that is configured to incorporate data error into the layer information and event information. Finally, a geospatial forecasting module can be configured to receive the layer information and event information with the incorporated data error and process the layer information and event information to determine one or more future events.

### BRIEF DESCRIPTION OF THE DRAWINGS

FIG. 1 is a block diagram of a geospatial forecasting system in accordance with an exemplary embodiment of the invention.

FIG. 2 is a flow chart illustrating an exemplary method for a geospatial forecasting method in accordance with an exemplary embodiment of the invention.

FIG. 3 is a flow chart illustrating an exemplary method for incorporating data error and uncertainty in a geospatial forecasting method in accordance with an exemplary embodiment of the invention.

FIG. 4 is picture illustrating data error and uncertainty in accordance with an exemplary embodiment of the invention.

FIG. 5(a) represents a hotspot of a sub region without incorporating data error and uncertainty.

FIG. 5(b) represents a hotspot of a sub region with incorporated data error and uncertainty in accordance with an exemplary embodiment of the invention.

### DETAILED DESCRIPTION OF EXEMPLARY EMBODIMENTS

Prior art forecast models and systems assume an exact knowledge of source data, assume data with high confidence levels, and do not account for uncertainty in retrieval, transformation, transmission, data presentation, and many other sources of error. For example, event locations are often generated by analysts relying on a variety of methods to quantify a position ranging from fairly accurate (e.g., global positioning systems) to approximations based on reports and articles. Geospatial information/data features are generally considered static, but questions arise about their currency, provenance, and accuracy as well. Geospatial event forecasts that do not account for uncertainty and data error may potentially mislead analysts, resulting in incorrect conclusions. Data error and uncertainty play a role throughout the complete process of generating event forecasts, ranging from data collection (e.g. event and feature data error) to generation of spatial likelihood functions (e.g., data retrieval and transformation, and methodological computational error generating probability density functions) to presentation of the forecasts (e.g., preparation of visual data, user interface representations, and user perception differences).

Referring now to the drawings, in which like numerals represent like elements, aspects of the exemplary embodiments will be described in connection with the drawing set.

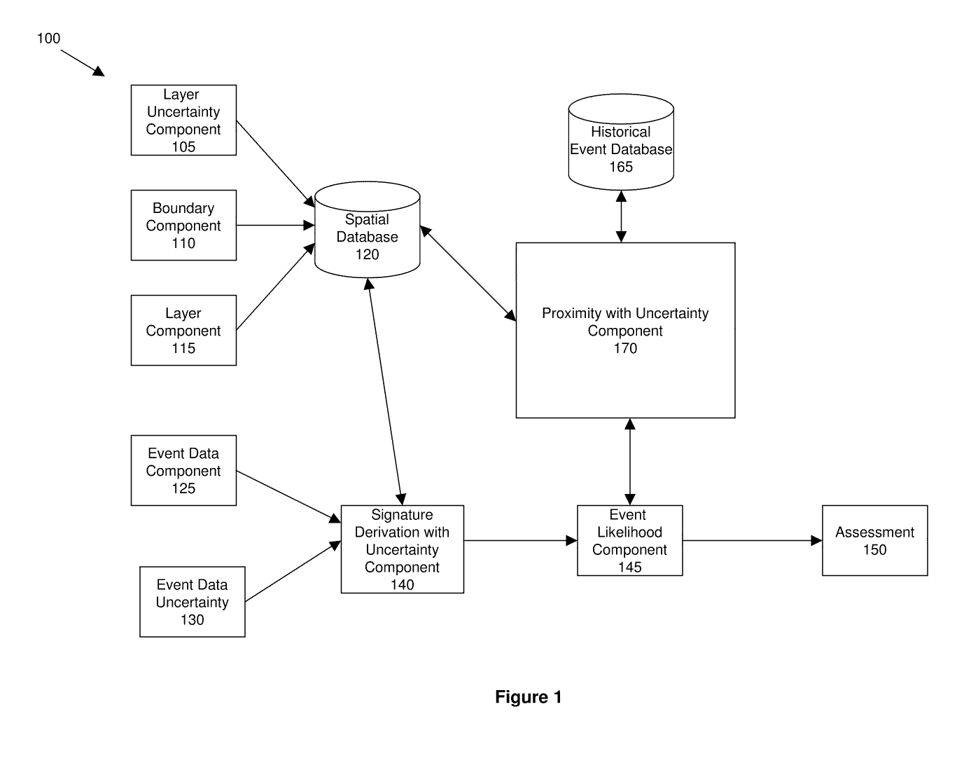

FIG. 1 is a block diagram of a geospatial forecasting system 100 in accordance with an exemplary embodiment of the invention. Certain features of the geospatial forecasting system 100 are known to one of ordinary skill in the art, and discussed in prior art references, such as U.S. Pat. No. 7,120,620. These features will be discussed herein as a frame of reference to an exemplary embodiment of the invention.

The geospatial forecasting system 100 can include a boundary component 110, or boundary module, which can allow the system or a user to set forth or incorporate a geospatial boundary to be analyzed. In one embodiment, the boundary component can specify individual cells within the boundary that are to be analyzed, and the cells can be provided in a grid overlay. In one embodiment, boundary information and cell information can be stored in spatial database 120 for one or more geographic areas of interest.

The system 100 can include a layer component 115, or layer module, which can allow the system or a user to specify or incorporate one or more layers of geospatial features or characteristics pertaining to at least one variable of interest. For example, a “roads” layer can be provided that has information pertaining to roads within a defined geospatial boundary. The roads layer can also be provided with additional variables of interest associated with roads, such as the number of lanes in a given road, whether the road is a highway or a city street, or whether the road is one-way or two-way. Other examples of types of layers can include: roads, cities, towns, cemeteries, embassies, gardens, industrial facilities, junctions, educational facilities, bodies of water, settlements, national parks, city or county facilities, bridges, hotels, fuel stations, hospitals, airports, train stations, parking lots, campsites, rest areas, archeological sites, and churches/holy places. Other layers can include demographic information such as age, gender, income, and/or religion type. Layer and variable data can be stored in spatial database 120.

In an exemplary embodiment of the invention, a layer uncertainty component 105, or layer uncertainty module, can be utilized by the geospatial forecasting system 100. One of the most important aspects of forecasting is having an estimate of the confidence in the supporting numerical values. For example, in weather prediction, there is always a value of confidence assigned with each forecast. For example, a prediction of 80% chance of rain can imply that the numerical weather modeler(s), for different variations of input parameter sets, predicted eight out of ten tries that it would rain. For event forecasts in an exemplary embodiment of the invention, several key sources of uncertainty should be considered. These sources of uncertainty can include positional uncertainty associated with geospatial locations for geographic, demographic, economic, political event, and historical-event data; error associated with reduction of features; and methodological error associated with the event forecasting algorithms.

For layer component information, data error and uncertainty can be applicable to wide variety of different types of layer features, including many of the layers listed previously. For example, a data layer feature with data error and uncertainty can include locations of settlements where groups of people live. The locations of settlements can change over time as groups of people move to different areas for a variety of reasons. For example, food and water supply, political and religious discourse, and a variety of other reasons can cause settlements to move. Thus, layer component information about settlements can be highly inaccurate if the settlement location information has not been verified in a more recent period of time. However, if settlement location information is more recent, the information can most likely be more accurate.

In an exemplary embodiment of the invention, the layer uncertainty component 105, layer uncertainty module, can provide a confidence value for the layer component information. For example, the confidence values can be assigned for the layer component on a rated scale from 1 to 5. A confidence value of 1 can represent highly accurate information, while a confidence level of 5 can represent highly inaccurate information. The confidence value for the one or more feature layers can subsequently be incorporated into the system 100 to produce a geospatial forecasting assessment.

A proximity component 170 can provide analysis for identifying and measuring a proximity measurement associated with an element of each cell. For each cell, the proximity component 170 can help determine a cell element from which measurements can be taken. The proximity component 170 can determine a measurement for each cell from the cell element (e.g., midpoint) to the variable of interest. In one embodiment, this measurement is the nearest neighbor distance. The proximity component 170 can store all measurements and calculations for later use when examining signature information associated with actual training data.

In one embodiment, the layer component 115 can include an update layer element that can operate to update the spatial database 120 upon receiving changes to existing layers or entirely new layers. The update layer element can trigger the layer component 115 to notify the proximity component 170 upon receipt of the updated or new layer, at which point the proximity component can either complete whatever current processing is occurring, or the proximity component 170 can delay any further processing until the updated or new layer is incorporated. To the extent the new or updated layer is part of the currently processing assessment, the proximity component 170 can re-initiate this segment of the analysis. In an exemplary embodiment of the invention, the updated layer element can incorporate the confidence values from the layer component uncertainty 115.

An event likelihood component (ELC) 145 can perform analysis based on signatures constructed from available actual data received. For example, the actual data can be received from an event data component 125, or event data module. The ELC 145 could use this event data, or training data, to determine likelihood of similar events occurring in the geospatial boundary. For example, the event data can be locations where previous armed robberies occurred.

In addition to utilizing the event data input component 125, the ELC 145 can also perform analysis based on signatures constructed from incorporating event data uncertainty information from an event data uncertainty module 130. As noted, event data can have data error and uncertainty associated with it that can impact a final assessment. The data error and uncertainty can be applicable to wide variety of event data. The most common example of event data error and uncertainty is typically position data. Other types of data error and uncertainty can be incorporated from a historical events database 165. This database can include data regarding many historical events that can be helpful in forecasting future events.

In an exemplary embodiment of the present invention, the layer uncertainty module 105 and the event data uncertainty module 130 can be stored in a layer information and event information uncertainty module. In another exemplary embodiment of the present invention, the layer module 115 and the event data module 125 can be stored in a layer information and event information module.

In the example discussed above for locations where previous armed robberies occurred, sometimes exact position data can be difficult to obtain. In a very inaccurate position example, the event data may only represent that the armed robbery occurred in a particular neighborhood or city. In a more accurate example, the data may represent the exact street location of where the armed robbery occurred. In this example, the event data uncertainty information can reflect a confidence value associated with the event data. Therefore, a confidence scale can be created where the less accurate position data (i.e., the general neighborhood or city description) for an armed robbery could have a low confidence value, such as a value of 5, while the more accurate position data (i.e., exact street address) could have a high confidence value, such as a value of 1. After creating the confidence scale, a confidence value can be determined for the event information (and for the layer information as discussed previously) based on the confidence scale.

Another example of event data error and uncertainty that is common in geospatial forecasting is location data received from a GPS device. For example, a personal GPS device that is commonly used in a vehicle (e.g., Garmin) typically has a known value of error, such as the device is accurate to a certain distance, such as +/−50 m. However, there may be more accurate GPS devices that consumers cannot purchase that typically are more accurate. For example, these devices may provide measurements that are accurate such to +/−10 m. Finally, there can special government location devices that can be accurate to a degree of +/−1 m. Therefore, with different types of location systems providing different degrees of accuracy with respect to location data, it can be important to factor in the data error and uncertainty into the training data, as well as factoring it in to the correct degree. In an exemplary embodiment, the system 100 can store these known values in the event data uncertainty information 130. The system 100 can be configured to assign confidence values to the event data based on the known error values in the event data uncertainty information 130. These confidence values, or confidence ratings, can represent the confidence about the precise location of the event data.

A signature derivation component 140 can receive and measure the event data and data uncertainty, and analyze the information against one or more of the layers entered in the spatial database 120 for a given geospatial boundary. The signature derivation component 140 can construct a raw signature, reducing the information into a histogram or probability density function and establish a signature pattern for this event type (e.g., armed robberies) within the geospatial boundary. The ELC 145 can receive the derived signature from the signature derivation component 140 that incorporates the data error and uncertainty, and then combine the signature with the measurements stored by the proximity component regarding each cell. Then, the ELC 145 can measure a level of signature match with one or more cells for the given event type.

More specifically, to incorporate the data error and uncertainty into event data, the ELC 145 can analyze the distance between key features and the event location as the highest likelihood, and taper the likelihood values as the distances increase or decrease away. This effect can be modeled using a kernel function (e.g., Gaussian function) centered at the distance between key features and the event. For the Gaussian kernel, the probability density function p for a given grid cell g and uncertainty estimates u can be given by:

$$p ( g , u ) = c {\prod }_{i = 1}^{l} \frac{1}{N} {\sum }_{n = 1}^{N} K ( {D}_{ig} - Din + u ( {φ}_{E} , {φ}_{F} ) )$$

$$where$$

$$K ( θ ) = \frac{1}{\sqrt{2 {πσ}_{i}^{2}}} {e}^{- \frac{{θ}^{2}}{2 {σ}_{i}^{2}}}$$

In the equation, u can represent a multivariate function consisting of several sources of data error and uncertainty. D_{ig} is the distance from the feature i to the grid cell, Dᵢₙ is the distance from the feature to event location n, c is a constant, φ_{E} and φ_{F} are the position uncertainty for event and features respectively, I is the total number of features, and N is the total number of events. This formulation can produce a range of possible values for grid points other than g. To account for the variation, the system can discretize the range of values and sampling by utilizing a Monte Carlo simulation approach, known to one of ordinary skill in the art.

In an exemplary embodiment of the present invention, the signature derivation component 140 and ELC 145 can be incorporated into a geospatial forecasting module configured to receive the layer information and event information with the incorporated data error and process the layer information and event information to determine one or more future events.

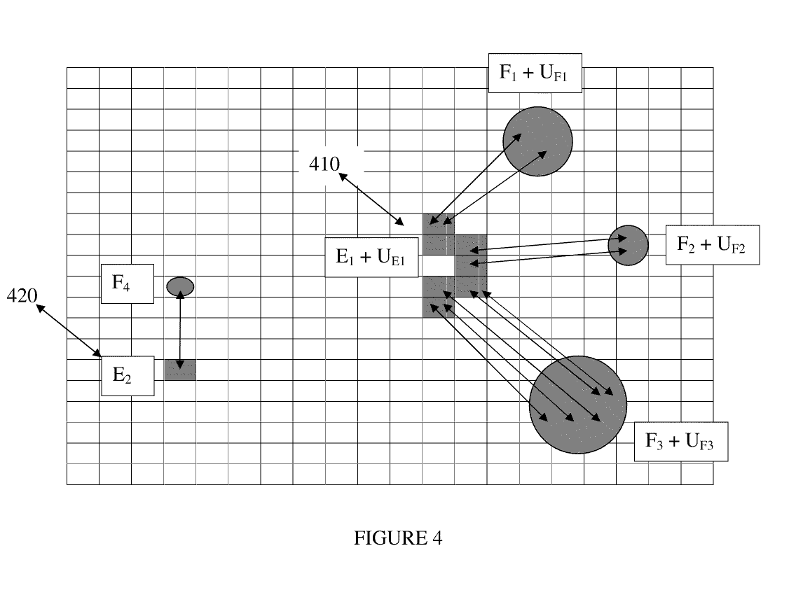

In an exemplary embodiment of the invention, FIG. 4 illustrates one type of data error and uncertainty that can be covered by this formulation. In FIG. 4, event E₁ can occupy up to seven grid points (410) and can be associated with up to three different features, F₁, F₂, F₃, with each feature also occupying several grid cells individually. In this example, the inclusion of data error and uncertainty in the formulation produces additional event location areas where future events may occur. However, in the prior art, the formulation could only produce a situation represented by E₂ (420), where there is only a single proximity calculation associated with single feature F₄.

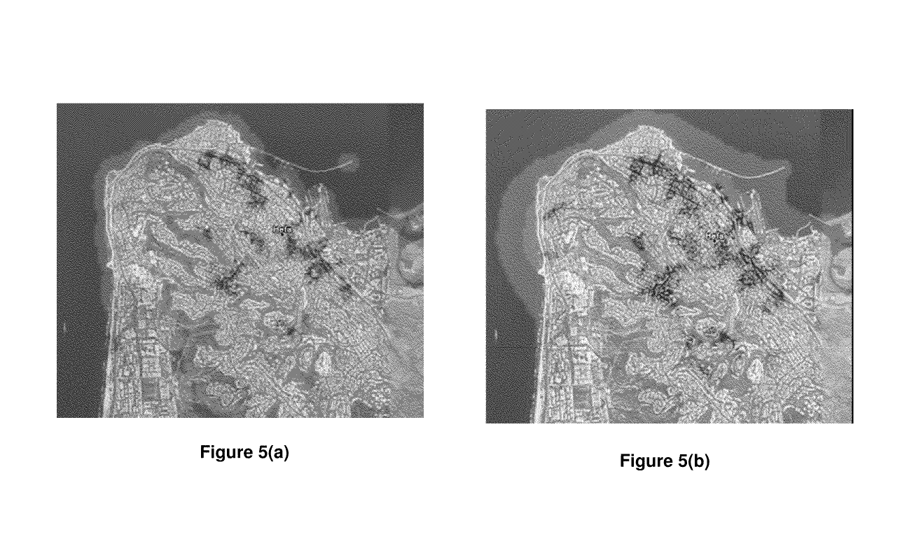

The level of signature match produced in the formulation can be provided as an assessment 150 which can be determined by calculating a score associated with each cell. In one embodiment, the scores can be plotted on a choropleth graph, which can give a viewer a “hot spot” type reading. FIGS. 5(a) and 5(b) can represent the impact of accounting for uncertainty. FIG. 5(a) represents a hotspot of a sub region (represented by the darker areas) without incorporating data error and uncertainty. FIG. 5(b) represents the hotspots with uncertainty and data error incorporated in the formulation. As represented in FIG. 5(b) the hotspot regions (darker areas) are typically spread out to represent an expanded area of potential forecasted events.

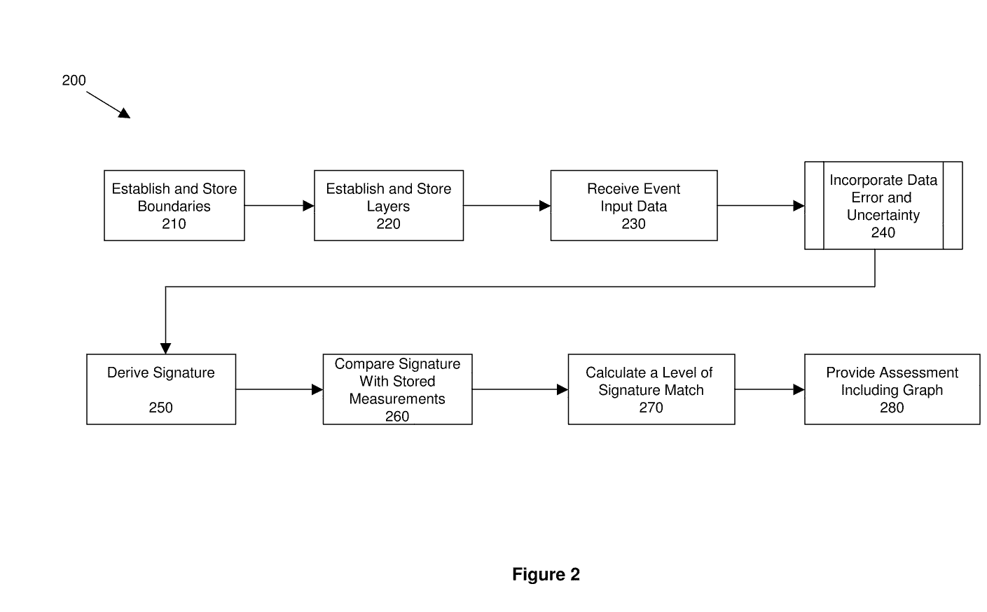

FIG. 2 is a flow chart illustrating an exemplary method 200 for a geospatial forecasting method in accordance with an exemplary embodiment of the invention. In Step 210, a geospatial boundary can be defined, for example, by a boundary module. For example, the geospatial boundary can be a 20-mile by 20-mile square area around Washington, D.C. Within this boundary, a grid of smaller geographical areas (i.e., cells) can be created. In Step 220, one or more layers having “variables of interest” (e.g., schools, roads, rivers, shopping centers, etc.) can be established and stored.

Next proximity measurements can be derived and stored for each cell and for each variable of interest. For example, for each cell, a proximity measurement can be determined for each of the different variables of interest. Once each cell has been measured according to the appropriate factor for the problem to be solved or event to be forecasted, the information pertaining to a location of a meaningful event or events (e.g., a robbery) can be received in Step 230. Specifically, the event data can be received from the event data input component 125. For example, the location information can be specified by block and street (e.g., 4400 block of Hill St.), by latitude and longitude, or other known formats.

In an exemplary embodiment of the invention, data error and uncertainty for input event data and for layers can be incorporated in Step 240. The data error and uncertainty for input event data can be stored in the event data uncertainty component 130. Additionally, layer error and uncertainty for feature layer information can be stored in the layer uncertainty component 105.

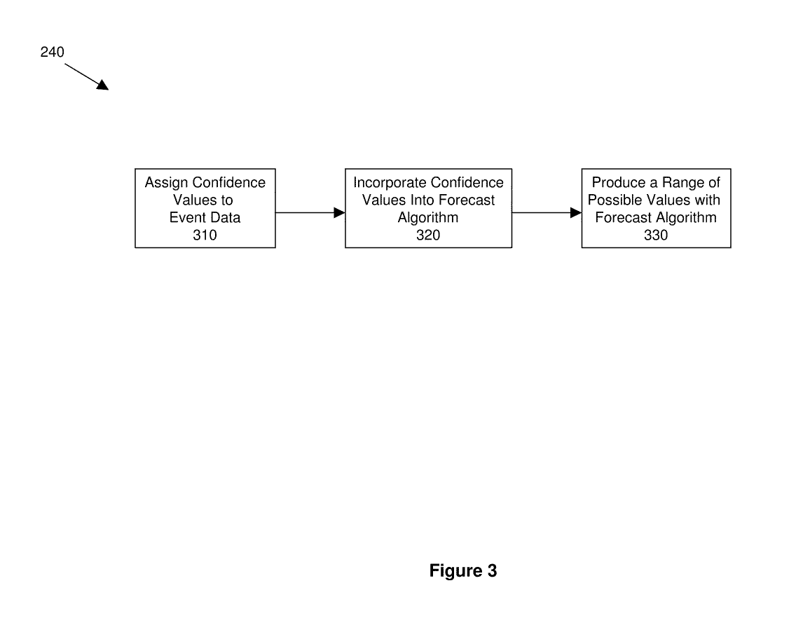

FIG. 3 is a flow chart illustrating an exemplary method 240 for incorporating data error and uncertainty in a geospatial forecasting method in accordance with an exemplary embodiment of the invention. In Step 310, confidence values can be assigned to layer component and event data. For example, the confidence values can be assigned for the layer component and event data on a rated scale from 1 to 5, representing a confidence in the accuracy of the data. In Step 320, the confidence values can be incorporated into a forecast algorithm. In Step 330, the forecast algorithm can produce a range of possible values of grid points.

Next, based on the received event data, the proximity of the event to the variables of interest (e.g., the robbery occurred 0.2 miles from a shopping center, 0.5 miles from a highway, and 2 miles from a river) can be identified based on the range of possible values of grid points. A “raw signature” for the event can then be established. The invention can measure a probability density function for each variable, so as to have a probability associating the events with a variable of interest.

In Step 250, a refined signature based on the probability density function can be established from the input event data and the event data uncertainty. In one embodiment of the invention, the probability density functions can be converted into a binary file, which can then be used in each of the cells outlined above. In Step 260, the event signature can be compared with the cell signatures previously determined and stored.

Next, in Step 270, for each of the cells, a score indicative of that cell's compatibility with the refined signature can be determined. Each cell can have a probability score associated with each variable. In an exemplary embodiment of the invention, the total score can be the sum of each of the probability scores.

In Step 280, once the cells have been given a score, the entire boundary can be viewed at a distance to determine geospatial “hot spots.” For instance, instead of limiting analysis to particular cells, the entire region can be analyzed for groups of cells that appear to have high probabilities of an event occurring.

The invention comprises a computer program that embodies the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement an exemplary embodiment based on the flow charts and associated description in the application text. Therefore, disclosure of a particular set of program code instructions is not considered necessary for an adequate understanding of how to make and use the invention. The inventive functionality of the claimed computer program will be explained in more detail in the following description read in conjunction with the figures illustrating the program flow.

It should be understood that the foregoing relates only to illustrative embodiments of the present invention, and that numerous changes may be made therein without departing from the scope and spirit of the invention as defined by the following claims.

1. A method for geospatial forecasting of events, comprising the steps of:
defining a geospatial boundary;
receiving a plurality of layer information and event information related to the geospatial boundary;
incorporating data error into the layer information and event information; and
processing the layer information and event information in a forecasting algorithm.

2. The method of claim 1, wherein the step of incorporating data error into the layer information and event information comprises assigning confidence values to the layer information and event information.

3. The method of claim 2, wherein the step of assigning confidence values to the layer information and event information comprises the steps of:
creating a confidence scale;
assigning a low confidence value at one end of the confidence scale;
assigning a high confidence value at the opposite end of the confidence scale; and
determining a confidence value for the layer information and event information based on the confidence scale.

4. The method of claim 1, wherein the event information comprises location data.

5. A method for incorporating data error and uncertainty into a geospatial forecasting of events, comprising the steps of:
receiving event data related to one or more past events;
assigning confidence values to each of the past events;
incorporating the confidence values and event data into a forecasting algorithm; and
processing the forecasting algorithm to determine one or more future events.

6. The method of claim 5, wherein the event data comprises location data.

7. The method of claim 5, wherein the step of assigning confidence values to each of the past events, comprises the steps of:
creating a confidence scale;
assigning a low confidence value at one end of the confidence scale;
assigning a high confidence value at the opposite end of the confidence scale; and
determining a confidence value for each event based on the confidence scale.

8. The method of claim 5, wherein the forecasting algorithm is a Gaussian function.

9. A system for geospatial forecasting of events, comprising:
a boundary module configured to define a geospatial boundary;
a layer information and event information module configured to store layer information and event information related to the geospatial boundary;
a layer information and event information uncertainty module configured to incorporate data error into the layer information and event information; and
a geospatial forecasting module configured to receive the layer information and event information with the incorporated data error and process the layer information and event information to determine one or more future events.

10. The system of claim 9, wherein the layer information and event information uncertainty module is configured to incorporate data error into the layer information and event information by assigning confidence values to the layer information and event information.
